(19) United States
(12) Patent Application Publication
(10) Pub. No.: US 2010/0285913 A1
(43) Pub. Date: Nov. 11, 2010

(54) Transmission With Dual IVT's And Planetary Gear Set

(76) Inventors: Roger W. Burjes, Independence, KS (US); John J. Bloomfield, Wamego, KS (US)

Correspondence Address: DEERE & COMPANY, ONE JOHN DEERE PLACE, MOLINE, IL, 61265, US

(21) Appl. No.: 12/436,519

(22) Filed: May 6, 2009

(51) Int. Cl. F16H 47/04

(52) U.S. Cl. 475/72

(57) ABSTRACT

A work machine includes an engine and a rear end coupled with the engine. The rear end includes a transmission having a first IVT with a first output shaft, and a second IVT with a second output shaft. A planetary gear set includes a sun gear coupled with the first output shaft, a ring gear coupled with the second output shaft, a plurality of planetary gears enmeshed between the sun gear and the ring gear, and a carrier gear coupled with each of the plurality of planetary gears. A final output includes a third output shaft carrying an output gear, with the output gear being enmeshed with the carrier gear.

### FIELD OF THE INVENTION

The present invention relates to work machines, and, more particularly, to transmissions used in such work machines.

### BACKGROUND OF THE INVENTION

A work machine, such as a construction work machine, an agricultural work machine or a forestry work machine, typically includes a prime mover in the form of an internal combustion (IC) engine. The IC engine may either be in the form of a compression ignition engine (i.e., diesel engine) or a spark ignition engine (i.e., gasoline engine). For most heavy work machines, the prime mover is in the form of a diesel engine having better lugging, pull-down and torque characteristics for associated work operations.

An IC engine in a work machine provides input power to a transmission, which in turn is coupled with and drives the rear axles through a rear end differential. The transmission, rear end differential and rear axles are sometimes referred to as the “rear end” of the work machine. The transmission typically is attached to the front of and provides input power to the rear end differential. The rear end differential provides ground power to the two rear axles. In the case of an agricultural work machine, the rear end differential also usually includes at least one power take-off (PTO) shaft extending rearwardly within the three point hitch arrangement at the rear of the tractor.

With a work machine as described above, it is common to provide a transmission with multiple shift ranges. Typically one shift lever is used to shift between multiple gear ranges (e.g., A, B, C and D gear ranges), and a second shift lever is used to shift between discrete gear pairs within each range (e.g., 1, 2, 3 or 4). The assignee of the present invention also markets a “PowerShift” series transmission in which at least one shift lever need not be foot clutched to shift “on-the-fly” during use. Variants of the PowerShift transmission go back to the 4020 series tractors manufactured in the 1960's.

Another type of transmission used in a work machine is an infinitely variable transmission (IVT) which provides continuous variable output speed from 0 to maximum in a stepless fashion. An IVT typically includes hydrostatic and mechanical gearing components. The hydrostatic components convert rotating shaft power to hydraulic flow and vice versa. The power flow through an IVT can be through the hydrostatic components only, through the mechanical components only, or through a combination of both depending on the design and output speed.

One example of an IVT for use in a work machine is a hydromechanical transmission which includes a hydraulic module coupled with a planetary gear set. Another example of an IVT for a work machine is a hydrostatic transmission which includes a hydraulic module coupled with a gear set.

In current applications, a direct-drive powershift, torque converter driven powershift, or hydrostatic driven discrete speed range transmission is typically used. Each of these configurations require some shifting to change the speed ratio of the gearbox to achieve the desired range of vehicle speeds (up to 17 mph for skidders, 24 mph for loaders).

What is needed in the art is a transmission which is easier and simpler to operate.

### SUMMARY OF THE INVENTION

The invention in one form is directed to a transmission for a vehicle, including a first variable speed drive having a first output shaft, and a second variable speed drive having a second output shaft. A planetary gear set includes a sun gear coupled with the first output shaft, a ring gear coupled with the second output shaft, a plurality of planetary gears enmeshed between the sun gear and the ring gear, and a carrier gear coupled with each of the plurality of planetary gears. A final output includes a third output shaft carrying an output gear, with the output gear being enmeshed with the carrier gear.

The invention in another form is directed to a work machine including an engine and a rear end coupled with the engine. The rear end includes a transmission having a first IVT with a first output shaft, and a second IVT with a second output shaft. A planetary gear set includes a sun gear coupled with the first output shaft, a ring gear coupled with the second output shaft, a plurality of planetary gears enmeshed between the sun gear and the ring gear, and a carrier gear coupled with each of the plurality of planetary gears. A final output includes a third output shaft carrying an output gear, with the output gear being enmeshed with the carrier gear.

### BRIEF DESCRIPTION OF THE DRAWINGS

FIG. 1 is a perspective view of an embodiment of a rear end of the present invention used in a work machine in the form of an agricultural tractor; and

FIG. 2 is a schematic illustration of an embodiment of a transmission of the present invention, which may be used in the rear end shown in FIG. 1.

### DETAILED DESCRIPTION OF THE INVENTION

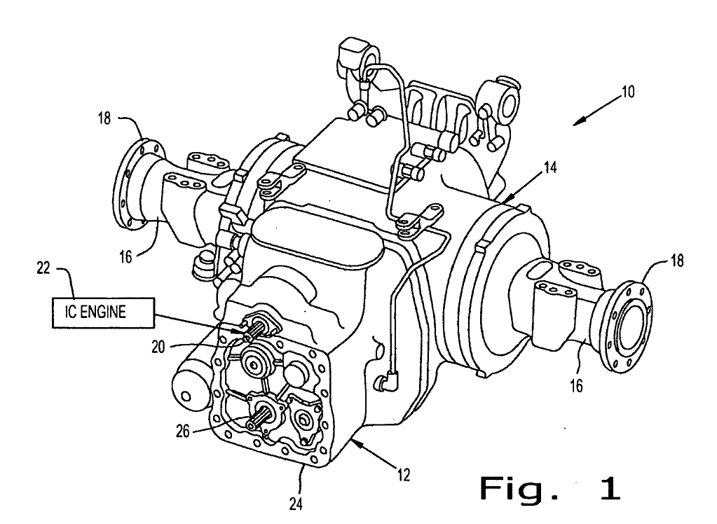

Referring now to the drawings, and more particularly to FIG. 1, there is shown a portion of a vehicle or work machine 10 in the form of an agricultural loader tractor, particularly the rear end drive train of the tractor. Although shown as an agricultural tractor, it is possible that vehicle or work machine 10 could be in the form of a different type of vehicle or work machine, such as a construction tractor or forestry machine.

Tractor 10 includes a rear end with a transmission 12 which is coupled with a rear end differential 14, which in turn drives a pair of rear axles 16. Each rear axle 16 includes an outboard hub 18 to which a respective rear drive wheel (not shown) is mounted. Although rear axles 16 are shown configured for carrying respective drive wheels, it is also possible that rear end differential 14 can be configured for driving a pair of ground engaging tracks.

Transmission 12 includes a driven shaft 20 which is mechanically coupled with and receives rotational input power from IC engine 22, shown schematically in FIG. 1. Driven shaft 20 extends through and is rotatably carried by housing 24, which likewise houses and rotatably carries a number of other components. For example, housing 24 may carry a clutch arrangement (not shown), which selectively interconnects with output shaft 26 so that the mechanical front wheel drive (MFWD) is engaged by actuation of a switch (not shown) in the operator's station.

Driven shaft 20 also transfers rotational power to other internal transmission components positioned within transmission housing 24. Rotational power is then transferred, according to a selected gear ratio, to rear end differential 14.

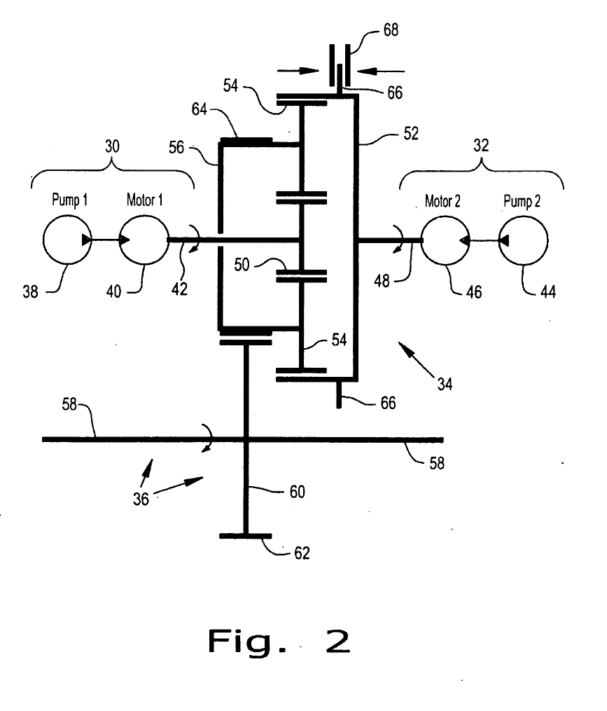

More particularly, and according to an aspect of the present invention, transmission 12 includes a number of internal components which are shown more specifically in FIG. 2. Namely, transmission 12 includes a first variable speed drive 30, a second variable speed drive 32, a planetary gear set 34, and a final output 36. In the illustrated embodiment, first variable speed drive 30 and second variable speed drive 32 are each in the form of an IVT, and, more particularly, in the form of a first hydrostatic transmission and a second hydrostatic transmission. However, it is to be understood that first variable speed drive 30 and second variable speed drive 32 could be configured as a different type of variable speed drive, depending upon the application. For example, first variable speed drive 30 could be configured as a first electrical motor and second variable speed drive 32 could be configured as a second electrical motor. Alternatively, rather than configuring each variable speed drive as an IVT in the form of a hydrostatic transmission, it is possible to configure each variable speed drive as a different type of IVT, such as a hydromechanical IVT.

First IVT 30 includes a variable displacement pump 38 and a variable displacement motor 40, with motor 40 being coupled with and driving a first output shaft 42. Second IVT 32 includes a variable displacement pump 44 and a fixed displacement motor 46, with motor 46 being coupled with and driving a second output shaft 48. In the embodiment shown, pump 44 of second IVT 32 is smaller than pump 38 of first IVT 30. However, it is to be understood that the relative sizes between pumps 38 and 44 can vary, depending upon the application. Similarly, the relative sizes between motors 40 and 46 may vary, depending on the application.

Planetary gear set 34 includes a sun gear 50, a ring gear 52, a plurality of planetary gears 54, and a carrier gear 56. Sun gear 50 is coupled with first output shaft 42 associated with first IVT 30. Ring gear 52 is coupled with second output shaft 48 associated with second IVT 32. The plurality of planetary gears 54 are enmeshed between sun gear 50 and ring gear 52. The number of planetary gears 54 which are actually used between sun gear 50 and ring gear 52 can vary, depending on the application. In the embodiment shown, it is assumed that four planetary gears 54 are enmeshed with sun gear 50 and ring gear 52. Carrier gear 56 is coupled with each of the plurality of planetary gears 54. More particularly, carrier gear 56 is coupled with each planetary gear 54 at the axis of rotation of each planetary gear 54, and thus rotates according to the translational speed of the planetary gears 54 about sun gear 50.

Final output 36 includes a third output shaft 58 which carries an output gear 60. Output gear 60 has a plurality of exterior teeth 62 which can enmesh with corresponding exterior teeth 64 on carrier gear 56. The diameter of output gear 60, and thus the relative gear ratio between carrier gear 56 and output gear 60, can vary, depending on the application. Third output shaft 58 extends axially from opposite ends of output gear 60. One end of third output shaft 58 is configured to drive the MFWD, while the other end of third output shaft 58 is configured to drive rear end differential 14. Thus, the front end of third output shaft 58 either corresponds to or is coupled with output shaft 26 leading to the MFWD. Third output shaft 58 also extends generally parallel to each of first output shaft 42 and second output shaft 48, given the orientation of the various gears shown in FIG. 2.

Transmission 12 also preferably includes an annular disk 56 which extends radially outward from ring gear 52. A brake 68 is configured to selectively engage annular disk 66 and thereby lock rotational movement of ring gear 52 during operation, as will be described in more detail below.

During operation, motor 40 drives sun gear 50, and motor 46 drives ring gear 52 in the same rotational direction. There are two modes of operation: 1) Ring gear 52 is locked with brake 68. This achieves the deepest gear reduction and highest tractive effort of work machine 10. 2) Brake 68 is released and ring gear 52 is driven by motor 46. This mode of operation reduces the speed ratio of transmission 12 and vehicle speed increases with increased speed of motor 46 in second IVT 32.

The present invention achieves an infinitely variable speed ratio from the deepest ratio of the planetary gear set 34 (around 6:1 with the ring gear 52 stationary) to a 1:1 or even overdrive ratio with the ring gear 52 at its maximum speed. Carrier gear 56 is the output of planetary gear set 34, and drives the single-gear output shaft 58 to drop the output center location and provide both a front and rear output from transmission 12.

Having described the preferred embodiment, it will become apparent that various modifications can be made without departing from the scope of the invention as defined in the accompanying claims.

1. A transmission for a vehicle, comprising:
a first variable speed drive having a first output shaft;
a second variable speed drive having a second output shaft;
a planetary gear set including a sun gear coupled with said first output shaft, a ring gear coupled with said second output shaft, a plurality of planetary gears enmeshed between said sun gear and said ring gear, and a carrier gear coupled with each of said plurality of planetary gears; and
a final output including a third output shaft carrying an output gear, said output gear enmeshed with said carrier gear.

2. The transmission of claim 1, wherein said first variable speed drive is a first infinitely variable transmission (IVT) and said second variable speed drive is a second IVT.

3. The transmission of claim 2, wherein said first IVT and said second IVT rotationally drive said sun gear and said ring gear in a same rotational direction, respectively.

4. The transmission of claim 2, wherein said first IVT includes a variable displacement pump and a variable displacement motor, and said second IVT includes a variable displacement pump and a fixed displacement motor.

5. The transmission of claim 4, wherein said pump in said second IVT is smaller than said pump in said first IVT.

6. The transmission of claim 1, including an annular disc extending radially outward from said ring gear, and a brake configured to selectively engage said annular disc.

7. The transmission of claim 1, wherein said carrier gear and said output gear each include exterior teeth enmeshed with each other.

8. The transmission of claim 1, wherein each of said first output shaft, said second output shaft and said third output shaft extend generally parallel to each other.

9. The transmission of claim 1, wherein said output shaft extends axially from opposite sides of said output gear.

10. The transmission of claim 9, wherein said output shaft is configured to drive a front end at one end thereof and a rear end at an opposite end thereof.

11. A work machine, comprising:
an engine; and
a rear end coupled with said engine, said rear end including a transmission, said transmission having:
a first infinitely variable transmission (IVT) having a first output shaft;
a second IVT having a second output shaft;
a planetary gear set including a sun gear coupled with said first output shaft, a ring gear coupled with said second output shaft, a plurality of planetary gears enmeshed between said sun gear and said ring gear, and a carrier gear coupled with each of said plurality of planetary gears; and
a final output including a third output shaft carrying an output gear, said output gear enmeshed with said carrier gear.

12. The work machine of claim 11, wherein said first IVT and said second IVT rotationally drive said sun gear and said ring gear in a same rotational direction, respectively.

13. The work machine of claim 11, wherein said first IVT includes a variable displacement pump and a variable displacement motor, and said second IVT includes a variable displacement pump and a fixed displacement motor.

14. The work machine of claim 13, wherein said pump in said second IVT is smaller than said pump in said first IVT.

15. The work machine of claim 11, including an annular disc extending radially outward from said ring gear, and a brake configured to selectively engage said annular disc.

16. The work machine of claim 11, wherein said carrier gear and said output gear each include exterior teeth enmeshed with each other.

17. The work machine of claim 11, wherein each of said first output shaft, said second output shaft and said third output shaft extend generally parallel to each other.

18. The work machine of claim 11, wherein said output shaft extends axially from opposite sides of said output gear.
